(19) United States
(12) Patent Application Publication
(10) Pub. No.: US 2009/0059714 A1
(43) Pub. Date: Mar. 5, 2009

(54) GRAVITY FLOW PROCESSOR FOR PARTICULATE MATERIALS

(75) Inventors: Ilya Pikus, Philadelphia, PA (US); Peter M. Koenig, Minneapolis, MN (US); Gregory J. Kimball, Blaine, MN (US); Ronald Halland, Circle Pines, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: BEPEX INTERNATIONAL, LLC, MINNEAPOLIS, MN (US)

(21) Appl. No.: 11/850,529

(22) Filed: Sep. 5, 2007

(51) Int. Cl. B01F 13/02; B01F 7/18; F26B 3/16

(52) U.S. Cl. 366/103; 34/505

(57) ABSTRACT

The present invention relates to purge vessel apparatuses and methods for processing particulate material composed of powder particles. Some such purge vessel apparatuses include a housing having first and second opposite ends and an inner surface defining a material path from the first end to the second end. Some such purge vessel apparatuses also include a gas exposure mechanism that is adapted to expose particulate material on the material path to a processing gas. Some such purge vessel apparatuses further include an agitating mechanism adapted to disrupt and/or inhibit formation of gas channels and/or to disrupt and/or inhibit formation of material flow channels by agitating particulate material on the material path, thereby exposing substantially all of the powder particles to the processing gas, while substantially maintaining mass flow. Several illustrative purge vessel apparatuses and method are disclosed for processing particulate material composed of powder particles.

### TECHNICAL FIELD

The present invention relates to apparatuses such as purge vessels, adapted for use in performing processes on particulate materials, as well as to methods of performing such processes.

### BACKGROUND

Various methods and corresponding apparatus designs exist for processing particulate materials with processing gas. One such apparatus is a purge vessel. A gas-solid interaction can occur within the purge vessel, and gas can be purged from the purge vessel. Many types of processes can be performed in purge vessels, including (a) drying or degassing particulate material, (b) chemically reacting particulate material, (c) heating (e.g., calcining) and/or cooling particulate material, (d) conditioning particulate material, (e) sterilizing particulate material, and/or (f) removing monomers from polymeric compositions, and so on.

Examples of purge vessels for performing processes on particulate material such as those listed above include (a) those designed to create a fluidized bed of particulate material (e.g., WO 95/15213 titled “Fluidization of a Bed of a Cohesive Powder” and the Fluid Bed Dryer/Cooler commercialized by Buhler AG of Switzerland), (b) those designed to thermoprocess flowable food products (U.S. Pat. No. 6,098,307 titled “Method for Treating Starch and Starch-Bearing Products”), and (c) those designed to crystallize amorphous material while providing slow speed agitation of the material to prevent agglomeration and minimize product degradation (e.g., the CL Series Resin Crystallizer offered by AEC, Inc.).

In many instances, achieving high material throughput in processing particulate material with gas can be important. In other words, exposing a large volume of particulate material to a processing gas over an accurately controlled period of time is often desirable. One way to achieve such throughput is by using a continuous-flow processing apparatus. Such apparatuses can often accommodate larger quantities of particulate material. In such an apparatus, particulate material is supplied to one part of the apparatus, processed within the apparatus, and discharged out of a different part of the apparatus. As compared with non-continuous flow apparatuses (e.g., batch-process apparatuses), continuous-flow processing apparatuses minimize time spent loading and unloading particulate material. Additionally, continuous-flow processing apparatuses can reduce the quantity of particulate material that is lost during the loading/unloading processes.

Similarly, in many instances, exposing a high percentage of a particulate material being processed to a processing gas can be important. Indeed, some processes (e.g., drying or degassing particulate material, and chemically reacting particulate material) require that a high percentage of the particulate material be exposed to the processing gas. In such processes, particles of the particulate material that are not exposed to the processing gas can go unprocessed. Therefore, it is desirable to maximize the extent to which particulate material is exposed to the processing gas.

The size of the particles that make up a particulate material can play an important role in the efficiency of exposing the particulate material to processing gas. Particulate materials are generally considered to include either granules or powders, with the former having particles larger than approximately 250 micro-meters, and the latter having particles smaller than that size. The actual size and distribution of particles, as well as other physical/chemical characteristics can determine both flow and other characteristics under any particular processing parameters.

Granules can generally be sufficiently exposed to processing gas in some continuous-flow processing apparatuses (e.g., a purge vessel commercialized by Bepex International of Minneapolis, Minn.). On the other hand, processing particulate material composed of powder particles can present significant difficulties related to sufficient exposure to processing gas because processing gas can have difficulty passing through the minimal space between the powder particles. Processing gas instead tends to form channels through the powder particles, thereby exposing the powder particles bordering the channels to an inordinate quantity of processing gas while leaving the rest of the powder particles insufficiently exposed to the processing gas. Such channels are illustrated schematically in FIG. 4, with reference number 1 referring to the particulate material and reference number 2 referring to the gas channels.

In many instances, processing particulate material composed of powder particles can present significant difficulties stemming from material flow channels (or “rat holes”). Material flow channels exist when some of the powder particles (often those in the center of the apparatus) are flowing at a substantially higher velocity than others. Material flow channels result in some of the powder particles getting exposed to processing gas for a substantially shorter time than others, which can lead to adverse consequences.

Additionally, in many instances, it is important to substantially maintain “mass flow” while processing particulate material with processing gas. For example, as compared with purge vessels that fluidize the bed of particulate material, a purge vessel that substantially maintains mass flow can provide several advantages. While various devices have been described to address these and similar concerns, including some referenced above, there remains a need for a continuous-flow processing apparatus that provide improved performance in various respects.

### SUMMARY

The present invention relates to a purge vessel apparatus and corresponding method for processing particulate material composed of powder particles, wherein the vessel is designed and used in a manner that sufficiently exposes particulate material that includes powder particles to processing gas while substantially maintaining mass flow. In a particularly preferred embodiment, the apparatus comprises a vessel containing a central rotating shaft having one or more arms serving as both a gas exposure mechanism and an agitating mechanism, in order to both agitate the powder within the vessel while delivering gas thereto.

In a preferred embodiment, the apparatus includes:
a housing having first and second opposite ends, the first end preferably adapted to be disposed vertically above the second end for operation, and an inner surface defining a material path from the first end to the second end,
the housing preferably including a housing shaft extending within the housing between the first and second ends and being adapted to rotate at a housing shaft speed, the housing shaft optionally containing one or more gas delivery lumens along at least a portion of its length;
a gas exposure mechanism associated with a gas source, the gas exposure mechanism adapted to expose particulate material on the material path to a processing gas,
the gas exposure mechanism optionally including one or more gas inlets positioned along the material path, the one or more gas inlets being adapted to receive processing gas from the gas delivery lumen; and
an agitating mechanism adapted to disrupt and/or inhibit formation of gas channels and/or to disrupt and/or inhibit formation of material flow channels by agitating particulate material on the material path, thereby exposing a predetermined or desired amount (and preferably substantially all) of the powder particles to the processing gas, while substantially maintaining mass flow,
the agitating mechanism preferably including one or more arms affixed to and extending from the housing shaft (e.g., generally radially and/or generally perpendicularly) toward the inner surface of the housing and being adapted to rotate at an arm speed that correlates with the housing shaft speed;
whereby the gas exposure mechanism and agitating mechanism cooperate to provide an optimal combination of gas flow kinetics, particulate flow kinetics, including mass flow, and efficiency of gas and particle contact.

The apparatus and method can be used for any suitable powder processing, including for instance, for use in processing polymers, pharmaceuticals, agricultural chemicals, and so on. In turn, the apparatus and method of this invention provide an optimal combination of product residence time, reaction rates, minimal side reactions, process controllability, efficiency, energy use, capital expenditure, plant profile and footprint, and/or environmental and safety benefits.

In preferred embodiments, the agitating mechanism can include one or more of the following features: a) a gas exposure mechanism that comprises the use of one or more gas inlets provided on one or more arms; b) a plurality of arms each affixed to and extending from the housing shaft toward the inner surface of the housing, the plurality of arms being selected from the group consisting of at least two arms that are affixed to the housing shaft at a common position along the length of the housing shaft (e.g., approximately symmetrically about the housing shaft), and at least two arms that are affixed to the housing shaft at different positions along the length of the housing shaft, the arms optionally also being offset from each other by an offset angle. In some embodiments, the first end of the apparatus's housing is adapted to be disposed vertically above the second end of the housing for operation, and the apparatus comprises a generally central rotating shaft having one or more arms serving as both a gas exposure mechanism and an agitating mechanism.

Some embodiments of the present invention can provide significant advantages over batch processes. Embodiments in which processing gas is counter-flowed can allow the purest processing gas (i.e., the processing gas with the least contaminants) to “fine-tune” particulate material that is nearly completely processed, while more saturated processing gas performs “rougher” processing on particulate material at earlier stages of processing. A continuous-flow process is often more likely to result in saturated processing gas, meaning that the gas can be used more efficiently. Embodiments in which the temperature of particulate material entering the housing is controlled can enhance processing within the housing. Some embodiments of the present invention allow for significantly greater capacity than batch processing apparatuses. Some embodiments of the present invention allow the heating and drying processes to be separated from each other, which can allow the heating apparatus and the drying apparatus to be used more efficiently.

A preferred method of the invention for processing particulate material composed of powder particles includes the following steps:
providing a purge vessel apparatus as described herein;
passing particulate material through a housing (e.g., downwardly and/or continuously) along a material path;
optionally controlling the temperature of particulate material entering the housing;
introducing processing gas into the housing (e.g., by passing processing gas through a first gas inlet);
agitating the particulate material to disrupt and/or inhibit formation of gas channels and/or to disrupt and/or inhibit formation of material flow channels in the particulate material, thereby exposing a predetermined or desired amount (and preferably, substantially all) of the powder particles to the processing gas while substantially maintaining mass flow, wherein agitating the particulate material preferably includes rotating a first arm within the housing through a first rotation path (which is optionally perpendicular to the material path) to contact at least some of the powder particles and the first arm optionally includes a first gas inlet; and
optionally discharging processed particulate material from the housing at a controlled rate.

### BRIEF DESCRIPTION OF THE FIGURES

FIG. 1 is a cross-sectional view of a purge vessel apparatus for processing particulate material composed of powder particles according to some embodiments of the present invention;

FIG. 2 is a sectional view (section A-A) of the apparatus of FIG. 1;

FIG. 3 is a sectional view (section B-B) of the apparatus of FIG. 1;

FIG. 4 is a schematic cross-sectional view of an apparatus housing;

FIG. 5 is a cross-sectional view of a purge vessel apparatus for processing particulate material composed of powder particles according to some embodiments of the present invention;

FIG. 6 is a sectional view (section C-C) of the apparatus of FIG. 5; and

FIG. 7 is a flow chart illustrating a method of processing particulate material composed of powder particles.

### DETAILED DESCRIPTION OF ILLUSTRATIVE EMBODIMENTS

The following detailed description of illustrative embodiments should be read with reference to the figures, in which like elements in different figures are numbered identically. The figures depict illustrative embodiments and are not intended to limit the scope of the invention. Rather, the present invention is defined solely by the claims.

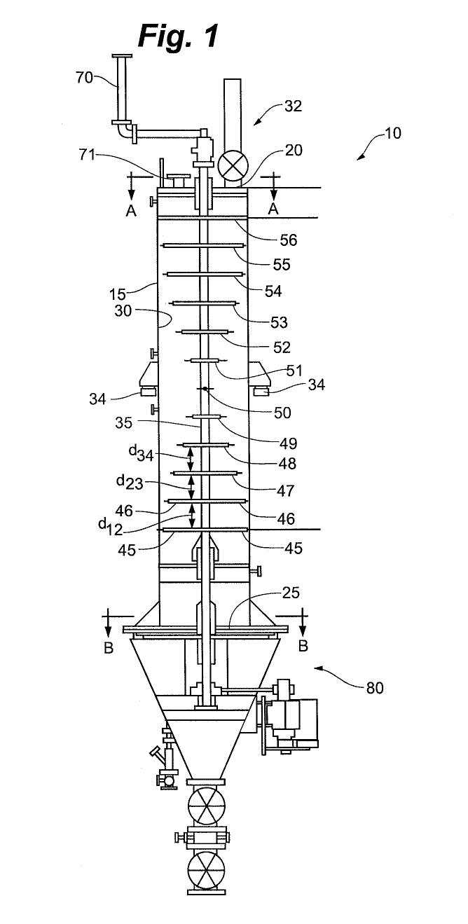

FIG. 1 shows one embodiment of a purge vessel apparatus 10 for processing particulate material composed of powder particles. Some embodiments are adapted to overcome the difficulties discussed above associated with passing processing gas through the minimal space between powder particles.

The purge vessel apparatus 10 of FIG. 1 includes a housing 15 within which the processing of the particulate material can occur. The housing 15 includes a first end 20 for receiving unprocessed particulate material and a second end 25 through which processed particulate material can pass. The first end 20 and the second end 25 can be on opposite ends of the housing 15, allowing the processing to occur in between.

In the purge vessel apparatus of FIG. 1, the housing 15 of the purge vessel apparatus 10 is generally cylindrical, though the housing can have any suitable cross-section, such as cylindrical as well, or in the form of an oval, or any suitable polygon, or any combination thereof. In some embodiments, the housing 15 is comprised of converging and diverging conical skirts. An example of such a housing can be found in U.S. Pat. Nos. 6,935,051 and 7,188,436, each titled “Heating and Drying Apparatus for Particulate Material,” which are commonly owned and are incorporated herein by reference in their entirety. The housing disclosed in such patents can be implemented with one or more features of the present invention. The converging and diverging conical skirts can disrupt particle flow, which can provide a variety of advantages, such as disruption of gas channel formation, breaking of cohesive forces between particles, relieving bulk static pressure experienced by particles, and so on.

The housing 15 of purge vessel apparatus 10 includes an inner surface 30, which defines a material path from the first end 20 to the second end 25. The temperature of the inner surface 30 of the housing 15 can optionally be controlled to suit the particular application, e.g., by the use of a heating element and associated control mechanism (not shown). The surface finish of the inner surface 30 of the housing 15 can have a significant impact on material flow in some instances.

Embodiments of the purge vessel apparatus 10 can include a variety of features. The purge vessel apparatus 10 of FIG. 1 includes a material delivery mechanism 32 adapted to deliver particulate material to the first end 20 of the housing 15. The temperature of the particulate material can be controlled as it enters the housing. The purge vessel apparatus 10 can include one or more load cells 34 or other means to determine the weight and/or level of the particulate material within the housing 15.

In many embodiments, the first end 20 of the housing is disposed vertically above the second end 25 for operation. In such purge vessel apparatuses (like that of FIG. 1), the material path is generally vertical, allowing the particulate material to flow with gravity (i.e., “gravity flow”). In many embodiments, it is desirable for the particulate material to flow along the material path in mass flow fashion, that is, movement of substantially all of the material away from the first end 20 and toward the second end 25. In this way, sufficient particulate material can be continuously introduced at the first end 20 to compensate for the continuous passing of particulate material through the second end 25, thereby ensuring that the housing 15 is substantially filled with particulate material from the first end 20 to the second end 25 during operation of the purge vessel apparatus 10.

The housing 15 of FIG. 1 includes a housing shaft 35, which extends within the housing 15 between the first end 20 and the second end 25. In many embodiments, the housing shaft 35 is adapted to rotate at a housing shaft speed. Commonly, the housing shaft speed is approximately 0.05-5 RPM, though other speeds are possible. The housing shaft speed can be designed in accordance with vertical velocity of the particulate material to ensure that each layer of particulate material is agitated by the agitating mechanism. In some embodiments, the housing shaft 35 includes a gas delivery lumen along at least a portion of its length. The gas delivery lumen can be coaxial with the housing shaft 35 and can extend within the housing shaft 35 or along the outside of the housing shaft 35. In such embodiments, processing gas can enter the gas delivery lumen at one position, flow within the gas delivery lumen along the corresponding portion of the housing shaft 35, and be introduced into the housing 15 at one or more other positions of the gas delivery lumen. Introducing processing gas to the housing in this manner is discussed in greater detail below.

The purge vessel apparatus 10 of FIG. 1 incorporates an agitating mechanism to address the problem(s) of gas channels and/or material flow channels forming in particulate material being processed. The agitating mechanism disrupts and/or inhibits formation of either or both of such channels by agitating particulate material on the material path. Disrupting and/or inhibiting formation of the gas channels can force the processing gas to travel the more difficult course through the spaces between the powder particles. Accordingly, the agitating mechanism can expose a predetermined or desired amount of the powder particles to the processing gas before it reaches the second end 25 of the housing 15. The amount exposed can either be a predetermined amount, based on various known parameters, and/or can be a desired amount, as determined, for instance, by periodic sampling of the particles in the course of their processing. Preferably, vessel apparatus is used in a manner that is intended to expose substantially all of the powder material in a desired fashion and to a desired extent.

Additionally, disrupting and/or inhibiting formation of the material flow channels can cause the particulate material to flow at a more uniform velocity, which can, in turn, expose the particulate material to processing gas for a more uniform duration. Moreover, the agitating mechanism can agitate the particulate material in such a way as to substantially maintain mass flow. In some embodiments, the agitating mechanism can provide additional benefits, such as breaking of cohesive forces between particles, relieving bulk static pressure experienced by particles, and so on.

The agitating mechanism of FIG. 1 includes a plurality of pairs of arms 45-56 adapted to provide a desired amount of agitation. A first pair of arms 45 is affixed to the housing shaft 35, with each arm extending from diametrically opposite sides of the housing shaft 35 toward the inner surface 30 of the housing 15. The arms of the first pair of arms 45 can extend generally radially and/or generally perpendicularly from the housing shaft 35. The first pair of arms 45 can be adapted to rotate at an arm speed, which can correlate to the housing shaft speed (discussed above). The arm speed can be adjusted to provide a desired amount of agitation. In many embodiments, the arm speed can be substantially equal to the housing shaft speed, though the arm speed can be faster or slower than the housing shaft speed (e.g., via separate drive systems). As the first pair of arms 45 rotates, the arms can agitate particulate material in a horizontal layer. Each arm can include a leading edge, which can be adapted to provide a desired amount of agitation. The leading edge can have a variety of attributes. For example, the leading edge can be generally curved, flat, pointed, or any suitable combination thereof.

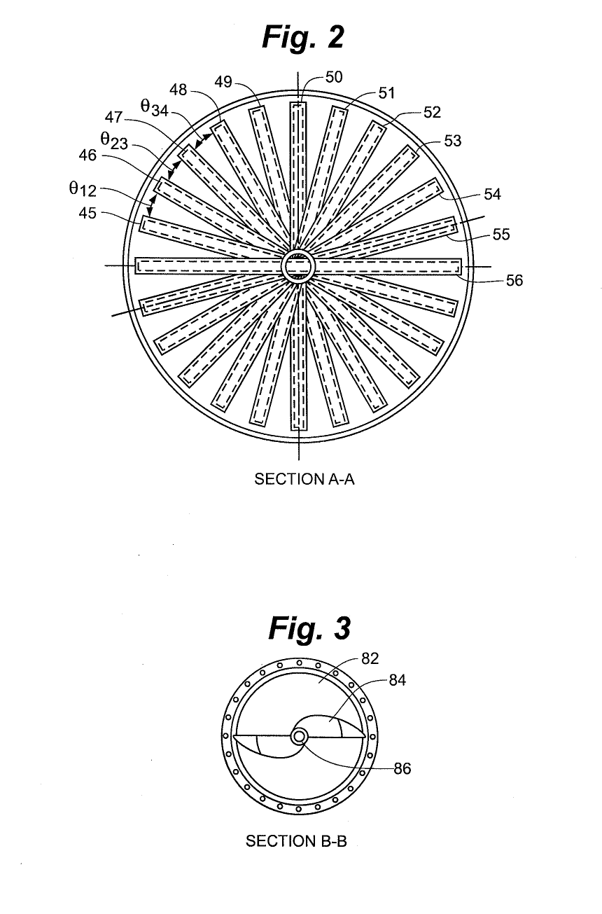

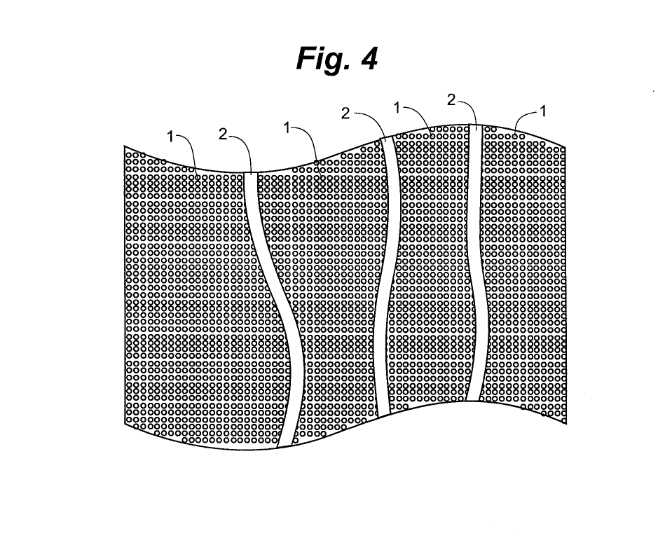

In purge vessel apparatuses in which processing gas flows from near the second end 25 toward the first end 20 past the first pair of arms 45, gas channels can re-form as the processing gas flows past the first pair of arms 45. The purge vessel apparatus 10 counters such re -forming of gas channels (and/or re-formation of material flow channels) with additional pairs of arms 46-56. The additional pairs of arms 46-56 are affixed to the housing shaft 35 at different positions along the length of the housing shaft 35. Like the first pair of arms 45, a second pair of arms 46 is affixed to the housing shaft 35, with each arm extending from diametrically opposite sides of the housing shaft 35 toward the inner surface 30 of the housing 15. The second pair of arms 46 is spaced a distance d₁₂ along the length of the housing shaft 35, and (as can be seen in FIG. 2) is offset by an angle θ₁₂, from the first pair of arms 45. As used herein, the subscript “12” denotes a relationship between the first pair of arms 45 and the second pair of arms 46. In the same way, a third pair of arms 47 is spaced a distance d₂₃ along the length of the housing shaft 35, and is offset by an angle θ₂₃, from the second pair of arms 46, and so on. As the housing shaft 35 rotates, the arms can agitate particulate material in horizontal layers. Each arm can include the same or different leading edges, which, as is discussed above, can be adapted to provide a desired amount of agitation.

Agitating mechanisms can include a variety of features to achieve the desired agitation for a given application, depending on the type of particulate material, the type of process being performed, and a host of other factors. For example, although the agitating mechanism of FIGS. 1-2 includes twelve pairs of arms 45-56, agitating mechanism embodiments can include more or fewer pairs of arms. Additionally, in the agitating mechanism of FIG. 1, the distances between the positions of the pairs of arms 45-56 along the length of the housing shaft 35 are approximately equal (d₁₂=d₂₃=d₃₄ and so on), but agitating mechanism embodiments can have any spacing between the pairs of arms 45-56. Similarly, in the agitating mechanism of FIG. 1, the offset angles between the pairs of arms 45-56 are approximately equal (0₁₂=0₂₃=0₃₄ and so on), but agitating mechanism embodiments can have any offset angles between the pairs of arms. The arm speed can be as fast or as slow as is desirable for a given application. Some agitating mechanism embodiments use single arms or groups of three or more arms (e.g., positioned symmetrically about the shaft) instead of pairs of arms. In some agitating mechanism embodiments, one or more arms are affixed to the housing shaft 35 at only one position along the length of the housing shaft 35. In some agitating mechanism embodiments, one or more arms are affixed to the housing shaft 35 at multiple different positions along the length of the housing shaft 35. Some agitating mechanism embodiments use a combination of single arms, pairs of arms, and/or larger groups of arms to agitate particulate material. In agitating mechanism embodiments having multiple arms, one or more arms can extend radially from the housing shaft 35, and one or more arms can extend at a suitable non-radial angle from the housing shaft 35. In agitating mechanism embodiments having multiple arms, one or more arms can extend perpendicularly from the housing shaft 35, and one or more arms can extend at a suitable non-perpendicular angle from the housing shaft 35. In some agitating mechanism embodiments, some arms have different dimensions (e.g., lengths) and/or shapes than other arms. In some agitating mechanism embodiments, one or more fixed arms extend radially inwardly from the inner surface of the housing toward the housing shaft. In such embodiments, the one or more fixed arms can be spaced so that the one or more rotating arms can rotate freely. The means by which the agitating mechanism of FIG. 1 agitates particulate material as it flows along the material path is provided only for illustration.

The purge vessel apparatus 10 of FIG. 1 includes a gas exposure mechanism that can be adapted to expose particulate material on the material path within the housing 15 to processing gas. Processing gas can enter the purge vessel apparatus 10 from a gas source through a gas pipe 70. Particulate material can be exposed to one or more processing gases. In some embodiments, multiple processing gases are adapted to perform multiple processes on the particulate material. Parameters of processing gas that enters the housing 15 can be controlled. In many embodiments, the temperature of the processing gas that enters the housing 15 is controlled to avoid heat loss in the particulate material and the inner surface 30 of the housing 15. In some embodiments, the rate at which the processing gas enters the housing 15 is controlled to ensure that no more processing gas is provided in the housing 15 than is necessary for processing the particulate material. By not relying on the processing gas to significantly contribute to particulate material agitation, some embodiments of the present invention make efficient use of processing gas. Several other parameters of the processing gas can also be controlled.

In some embodiments, the gas exposure mechanism includes one or more gas inlets (described in greater detail below), through which processing gas can enter the housing 15, and one or more gas outlets 71, through which processing gas and/or gaseous reaction products can exit the housing 15, positioned along the material path. In such embodiments, the respective locations of the one or more gas inlets and the one or more gas outlets 71 define a gas pathway. In many such embodiments, the gas pathway and the material path are in generally opposed directions. In gas exposure mechanism embodiments in which the gas pathway and the material path are in generally opposed directions, processing gas can be introduced into the housing 35 near the second end 25 of the housing 15 and can be flowed toward the first end 20 of the housing 15. This kind of flow pattern is commonly called counter-flow or counter-current flow, and it can be achieved by making the pressure near the second end 25 of the housing 15 greater than the pressure near the first end 20 of the housing 15. Counter-flowing processing gas can allow the purest processing gas (i.e., the processing gas with the least contaminants) to “fine-tune” particulate material that is nearly completely processed, while more saturated processing gas performs “rougher” processing on particulate material at earlier stages of processing.

As was mentioned above, in many embodiments, the housing shaft 35 contains a gas delivery lumen along at least a portion of its length for receiving processing gas from a gas source. In such embodiments, processing gas can enter the gas delivery lumen at one position, flow within the gas delivery lumen along the corresponding portion of the housing shaft 35, and be introduced into the housing 15 through one or more gas inlets at one or more other positions of the gas delivery lumen. In the purge vessel apparatus 10 of FIG. 1, processing gas can be received by the gas delivery lumen from the gas pipe 70, which can receive processing gas from a gas source. The processing gas can flow through the gas delivery lumen from near the first end 20 of the housing 30 toward the second end 25 of the housing. In this embodiment, at least a portion of the gas delivery lumen is positioned between the first end 20 of the housing 15 and the gas inlet nearest the first end 20 of the housing 15. When the processing gas is near the second end 25 of the housing 30, one or more gas inlets can receive the processing gas from the gas delivery lumen, thereby introducing the processing gas into the housing 30. Once in the housing 30, the processing gas can be flowed toward the first end 20 of the housing 30. Embodiments having multiple gas inlets typically also have multiple gas outlets. Some embodiments in which processing gas is introduced into the housing 15 at multiple positions of the gas delivery lumen benefit from purer processing gas contacting particulate material at multiple stages of processing.

The one or more gas inlets of the gas exposure mechanism can be provided in a variety of locations. In some embodiments, one or more gas inlets are provided on one or more of the arms of the agitating mechanism, and processing gas can be received by the gas inlet(s) through the arm(s) from the gas delivery lumen. Providing one or more gas inlets on an arm allows gas to be introduced into the housing 15 while the arm rotates about the housing shaft 35. Commonly, in embodiments in which gas inlets are provided on an arm, at least one gas inlet is provided on the side of the arm facing the second end 25 of the housing 15. In this way, when processing gas is introduced into the housing 15, the likelihood of disrupting mass flow is reduced. In some embodiments, at least one gas inlet is provided on multiple arms positioned at a common position, and/or different positions, along the length of the housing shaft 35.

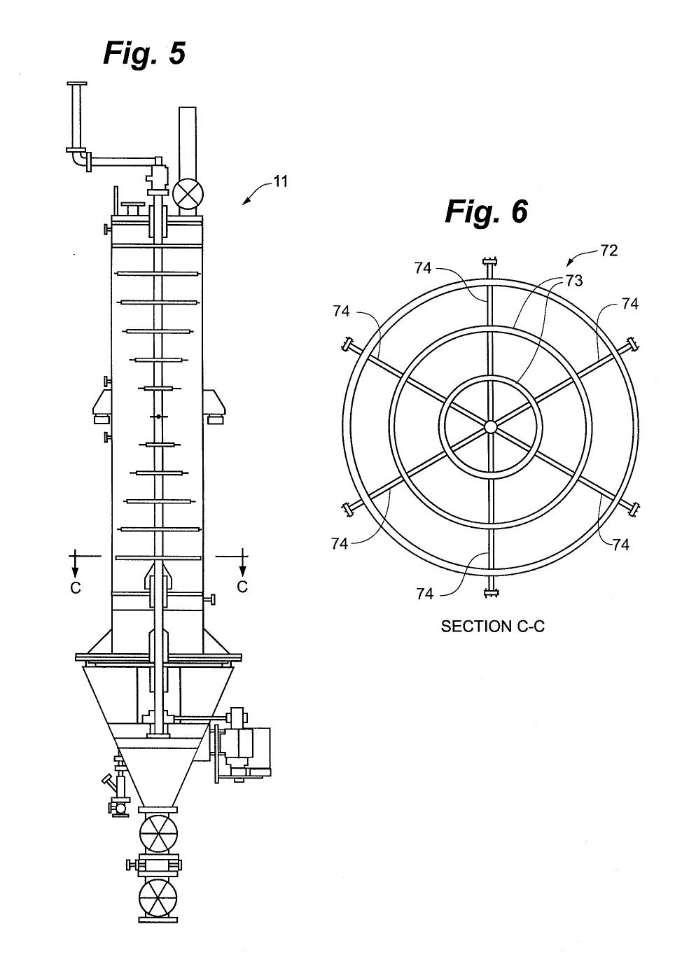

FIG. 5 shows a purge vessel apparatus 11 (similar to that of FIG. 1) for processing particulate material composed of powder particles. In purge vessel apparatus 11, In the embodiment of FIGS. 5-6, the one or more gas inlets of the gas exposure mechanism are provided on a stationary ring assembly 72. The stationary ring assembly 72 includes multiple concentric rings 73 supported by support members 74. One or more gas inlets can be provided on the rings 73 and/or the support members 74 at any suitable location(s), including on any suitable side. Gas inlets provided on the ring assembly 72 can receive processing gas from a gas source through a gas delivery lumen contained by the housing shaft or through any suitable conduit (e.g., through a gas tube in communication with the ring assembly 72 at any suitable location). The support members 74 can be attached to the housing in any suitable way (e.g., welding).

Referring again to FIG. 1, the purge vessel apparatus 10 includes a material removal mechanism 80 adapted to remove the particulate material from the second end 25 of the housing 15 at a controlled rate. In the embodiment of FIGS. 1-3, as particulate material exits the second end 25 of the housing 15, it contacts a substantially circular plate 82 and is swept by one or more sweep blades 84, which are rotated by a discharge shaft 86, through a gap defined by the plate and the second end 25 of the housing 15. In many embodiments, the second end 25 of the housing 15 defines an aperture. The plate 82 can be positioned proximate, and oriented generally parallel, to the aperture defined by the second end 25 of the housing 15. When the plate 82 is so positioned and so oriented, a gap is defined between the plate 82 and the aperture. The discharge shaft 86 can be coaxial with the housing shaft 35. In some embodiments, the discharge shaft 86 can be coupled to the housing shaft 35. The discharge shaft 86 can extend through the center of the plate 82. The discharge shaft 86 can be operable to rotate at a discharge shaft speed. The sweep blades 84 can have a leading edge that is adapted to sweep particulate material from the plate 82 toward the gap defined by the plate and the aperture.

In some embodiments, the material removal mechanism 80 can be adapted to empty the housing 15 of particulate material. With the material delivery mechanism 32 prevented from delivering particulate material to the first end 20 of the housing 15, the material removal mechanism 80 can empty the housing 15 of particulate material by ensuring that the discharge shaft 86 is not coupled to the housing shaft 35 and by increasing the discharge shaft speed.

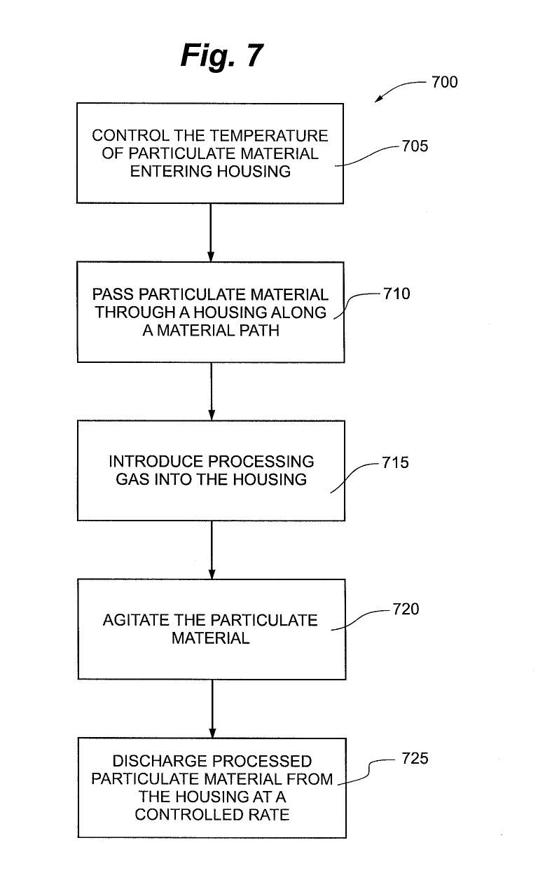

The purge vessel apparatuses described herein can be used in a variety of ways. FIG. 7 is a flow chart illustrating a method (700) of processing particulate material composed of powder particles. The first step of the method (700) of FIG. 7 is to optionally control the temperature of particulate material entering the housing (705). The second step of the method (700) is to pass particulate material through a housing along a material path (710). In some instances, the particulate material can be passed downwardly through the housing and/or on a continuous basis. The third step of the method (700) is to introduce processing gas into the housing (715). The fourth step of the method (700) is to agitate the particulate material (720). Agitating the particulate material (720) can disrupt and/or inhibit formation of gas channels and/or can disrupt and/or inhibit formation of material flow channels in the particulate material, thereby exposing substantially all of the powder particles to the processing gas while substantially maintaining mass flow. In some instances, agitating the particulate material (720) can include rotating a first arm within the housing through a first rotation path to contact at least some of the particulate material. In some such instances, the first rotation path is generally perpendicular to the material path. In instances in which agitating the particulate material (720) includes rotating a first arm within the housing, the first arm can include a first gas inlet, and introducing processing gas into the housing (715) can include passing processing gas through the first gas inlet into the housing. In some instances, agitating the particulate material (720) can include rotating a first arm within the housing through a first rotation path to contact at least some of the powder particles and rotating a second arm within the housing through a second rotation path to contact at least some of the powder particles. The first rotation path and the second rotation path can be at different positions along the length of the housing. In instances in which agitating the particulate material (720) includes rotating first and second arms within the housing, the first arm can include a first gas inlet, the second arm can include a second gas inlet, and introducing processing gas into the housing (715) can include passing processing gas through the first and second gas inlets into the housing. The fifth step of the method (700) is to optionally discharge the particulate material from the housing at a controlled rate (725). The method (700) discussed herein is for illustration only. Any of the functionality discussed herein in connection with a purge vessel apparatus (see FIGS. 1-3, 5-6) may also be implemented by a method.

Thus, embodiments of the gravity flow processor for particulate materials are disclosed. One skilled in the art will appreciate that the gravity flow processor for particulate materials can be practiced with embodiments other than those disclosed. The disclosed embodiments are presented for purposes of illustration and not limitation, and the present invention is limited only by the claims that follow.

What is claimed is:

1. A purge vessel apparatus for processing particulate material composed of powder particles, the purge vessel apparatus comprising:
a housing having first and second opposite ends and an inner surface defining a material path from the first end to the second end;
a gas exposure mechanism adapted to expose particulate material on the material path to a processing gas; and
an agitating mechanism adapted to disrupt and/or inhibit formation of gas channels and/or material flow channels by agitating particulate material on the material path, thereby exposing a predetermined or desired amount of the powder particles to the processing gas, while substantially maintaining mass flow.

2. The purge vessel apparatus of claim 1, wherein the first end of the housing is adapted to be disposed vertically above the second end of the housing for operation, and the apparatus comprises a generally central rotating shaft having one or more arms serving as both a gas exposure mechanism and an agitating mechanism.

3. The purge vessel apparatus of claim 1, wherein the housing includes a housing shaft extending within the housing between the first and second ends and being adapted to rotate at a housing shaft speed.

4. The purge vessel apparatus of claim 3, wherein the agitating mechanism includes an arm affixed to and extending from the housing shaft toward the inner surface of the housing and being adapted to rotate at an arm speed, which correlates to the housing shaft speed.

5. The purge vessel apparatus of claim 4, wherein the arm extends generally radially and/or generally perpendicularly from the housing shaft.

6. The purge vessel apparatus of claim 4, wherein the arm has a leading edge adapted to provide a desired amount of agitation, and/or wherein the leading edge is generally curved, flat, pointed, or any suitable combination thereof.

7. The purge vessel apparatus of claim 3, wherein the agitating mechanism includes a plurality of arms each affixed to and extending from the housing shaft toward the inner surface of the housing.

8. The purge vessel apparatus of claim 7, wherein at least two of the plurality of arms are affixed to the housing shaft at a common position along the length of the housing shaft.

9. The purge vessel apparatus of claim 8, wherein the arms that are affixed to the housing shaft at a common position along the length of the housing shaft are positioned approximately symmetrically about the housing shaft.

10. The purge vessel apparatus of claim 7, wherein at least two of the plurality of arms are affixed to the housing shaft at different positions along the length of the housing shaft.

11. The purge vessel apparatus of claim 10, wherein at least two of the arms that are affixed to the housing shaft at different positions along the length of the housing shaft are offset from each other by an offset angle.

12. The purge vessel apparatus of claim 7, wherein a first pair of arms is affixed to the housing shaft at a first common position along the length of the housing shaft and a second pair of arms is affixed to the housing shaft at a second common position along the length of the housing shaft, the first common position being different from the second common position.

13. The purge vessel apparatus of claim 3, wherein the housing shaft contains a gas delivery lumen along at least a portion of its length and the gas exposure mechanism includes one or more gas inlets positioned along the material path, the one or more gas inlets being adapted to receive processing gas from the gas delivery lumen.

14. The purge vessel apparatus of claim 13, wherein at least a portion of the gas delivery lumen is positioned between the first end of the housing and the gas inlet nearest the first end of the housing.

15. The purge vessel apparatus of claim 13, wherein the agitating mechanism includes an arm affixed to and extending from the housing shaft toward the inner surface of the housing, and wherein at least one of the one or more gas inlets is provided on the arm.

16. The purge vessel apparatus of claim 15, wherein at least one of the one or more gas inlets is provided on a side of the arm facing the second end of the housing.

17. The purge vessel apparatus of claim 13, wherein the agitating mechanism includes at least two arms each affixed to and extending from the housing shaft toward the inner surface of the housing, the at least two arms being affixed to the housing shaft at different positions along the length of the housing shaft, having at least one gas inlet provided on each arm, and being adapted to receive processing gas from the gas delivery lumen.

18. The purge vessel apparatus of claim 1, wherein the gas exposure mechanism includes one or more gas inlets and one or more gas outlets positioned along the material path, the respective locations of the one or more gas inlets and the one or more gas outlets defining a gas pathway, and wherein the gas pathway and the material path are in generally opposed directions.

19. The purge vessel apparatus of claim 1, further comprising a material delivery mechanism adapted to deliver particulate material to the first end and a material removal mechanism adapted to remove the particulate material from the second end of the housing at a controlled rate.

20. The purge vessel apparatus of claim 19, wherein the second end of the housing defines an aperture and the material removal mechanism comprises (a) a substantially circular plate positioned proximate to, and oriented generally parallel to, the aperture defined by the second end of the housing, thereby defining a gap between the plate and the aperture, (b) a discharge shaft optionally coaxial with and/or couplable to the housing shaft, extending through the center of the plate, and operable to rotate at a discharge shaft speed, and (c) one or more sweep blades affixed to and extending radially from the discharge shaft toward the gap defined by the plate, the one or more sweep blades having a leading edge adapted to sweep particulate material from the plate toward the gap defined by the plate.

21. A method of processing particulate material composed of powder particles, the method comprising:
providing a purge vessel apparatus adapted to process particulate material, the purge vessel apparatus including:
a housing having first and second opposite ends and an inner surface defining a material path from the first end to the second end,
a gas exposure mechanism that is adapted to expose particulate material on the material path to a processing gas, and
an agitating mechanism adapted to disrupt and/or inhibit formation of gas channels and/or to disrupt and/or inhibit formation of material flow channels by agitating particulate material on the material path, thereby exposing a predetermined or desired amount of the powder particles to the processing gas, while substantially maintaining mass flow; and
delivering particulate material to the purge vessel apparatus.

22. The method of claim 21, wherein delivering particulate material to the purge vessel apparatus comprises delivering particulate material to the purge vessel apparatus on a continuous basis.

23. The method of claim 21, wherein the agitating mechanism of the purge vessel apparatus includes an arm affixed to and extending from the housing shaft toward the inner surface of the housing, the arm having a leading edge that is (a) generally curved, (b) generally flat, (c) generally pointed, or (d) some combination of (a), (b), and (c).

24. A purge vessel apparatus for processing particulate material composed of powder particles, the apparatus comprising:
a generally cylindrical housing having first and second opposite ends and an inner surface defining a material path from the first end to the second end;
gas exposure means for exposing particulate material on the material path to a processing gas; and
agitation means for disrupting and/or inhibiting formation of gas channels and/or for disrupting and/or inhibiting formation of material flow channels by agitating particulate material on the material path, thereby exposing a predetermined or desired amount of the powder particles to the processing gas, while substantially maintaining mass flow.

25. A method of processing particulate material composed of powder particles, the method comprising:
passing particulate material through a housing along a material path;
introducing processing gas into the housing;
agitating the particulate material to disrupt and/or inhibit formation of gas channels and/or to disrupt and/or inhibit formation of material flow channels, thereby exposing a predetermined or desired amount of the powder particles to the processing gas while substantially maintaining mass flow.
